(19) United States
(12) Patent Application Publication
(10) Pub. No.: US 2007/0042629 A1
(43) Pub. Date: Feb. 22, 2007

(54) Latch for connector

(76) Inventor: Kazuya Okano, Kanagawa (JP)

Correspondence Address: HARRINGTON & SMITH, LLP, 4 RESEARCH DRIVE, SHELTON, CT, 06484-6212, US

(21) Appl. No.: 10/569,621

(22) PCT Filed: Aug. 27, 2004
(86) PCT No.: PCT/JP04/12357

§ 371 Date: Oct. 23, 2006

(30) Foreign Application Priority Data
Aug. 29, 2003 (JP) 2003-306258

(51) Int. Cl. H01R 13/625

(52) U.S. Cl. 439/345

(57) ABSTRACT

Engagement of a connector is not released even when vibration or impact, etc. in the front-back and up-down directions is applied to the connector. Further, deformation and breakage of a latch member by dynamic stress when fitting is release are prevented. A latch device for a connector has an engagement member adapted for engagement and latching between a first connector and a second connector, where an electrically conductive member is connected to the first member and the second connector has contacts and makes electrical connection to a circuit board. The engagement member has two arm sections extended in the longitudinal axis direction. A first arm section engaging with a corresponding connector has a first projection section and a second projection section, the first projection section being extended to the second arm section side, the second projection section being extended to the outer side relative to the connector inserting direction. The second arm section has a stopper supported by a supporting section extended to the outer side relative to the connector. When the first arm is bent toward the outside of the connector, the stopper comes into contact with the first arm to stop the bending, and the first projection section causes an engagement section of the first connector to come in an engagement while resisting a tensile force in the longitudinal axis direction.

### TECHNICAL FIELD

The present invention relates to a latch structure for maintaining engagement when fitting connectors together.

### BACKGROUND ART

While latch structures have been conventionally used to maintain the engagement of connectors, there is the possibility that vibrations or tensile force on cables connected to the connectors can affect the latches.

Patent Document 1: Japanese Patent Application, First Publication No. H6-236781

Patent Document 2: Japanese Patent Application, First Publication No. H7-192810

### DISCLOSURE OF THE INVENTION

Problems to be Solved by the Invention

Thus, a latch structure that is not affected by vibrations, tensile forces and the like has been desired.

Means for Solving the Problems

The invention offers a latch device for a connector; the latch device

being a member for engaging and latching when fitting together a first connector to which a conductive member is connected and a second connector having contacts for electrically connecting to a substrate; said engaging member comprising two arms extending in a longitudinal direction; a first arm portion engaging with a corresponding engaging portion of a connector comprising a first projecting portion extending toward a second arm portion and a second projecting portion extending outward with respect to a direction of insertion of the connector; said second arm portion comprising a stopper supported on a supporting portion extending outward with respect to the direction of insertion of the connector; the connector being latched by said stopper, when said first arm portion is bent to the outside of the contacts, coming into contact with said first arm portion to stop the bending; said first projecting portion opposing tensile force in a longitudinal direction to detain the engaging portion of said first connector; and the second projecting portion, when said first arm bends in a direction opposite to the second arm, coming into contact with said stopper to stop the bending. Due to this device, disengagement of an engaging portion engaged to the first arm can be prevented by a stopper connected to the second arm.

The stopper has an abutment portion that abuts the second projecting portion and a contact portion that contacts the first arm portion. As a result, the movement of the first arm can be restricted. Furthermore, the first arm has a taper to guide said engaging portion when latching the engaging portion of said first connector. Additionally, the first arm or second arm is formed of an elastic member, so that the first arm will flex when latching to allow for smooth engagement. Furthermore, the latch structure is provided symmetrically to both right and left sides of a connector, thus achieving a latch that reliably maintains the engagement of the connectors.

### BRIEF DESCRIPTION OF THE DRAWINGS

FIG. 1: FIG. 1 is a perspective view of an engaging portion corresponding to the latch member of the present invention.

FIG. 2: FIG. 2 is a perspective view of a connector provided with the latch member of the present invention.

FIG. 3: FIG. 3 is a perspective view of a connector latched by the latch member of the present invention.

FIG. 4: FIG. 4 is section view along the line A-A′ in FIG. 3; (a) showing the state where force is applied to the connector and (b) showing the state where the first arm is in contact with the stopper.

FIG. 5: FIG. 5 is a perspective view of the connector shown in FIG. 3, seen from the opposite side, i.e. from below.

### DESCRIPTION OF REFERENCE NUMBERS

1 first arm
2 second arm
3 first projecting portion
4 second projecting portion
5 stopper
6 communicating portion
7 engaging portion
8 taper
9 securing portion
10 engaging surface
11 latch member
12 second connector
13 right-left direction
14 front-rear direction
15 up-down direction
16 conductive member
17 side surface of engaging portion

### BEST MODE FOR CARRYING OUT THE INVENTION

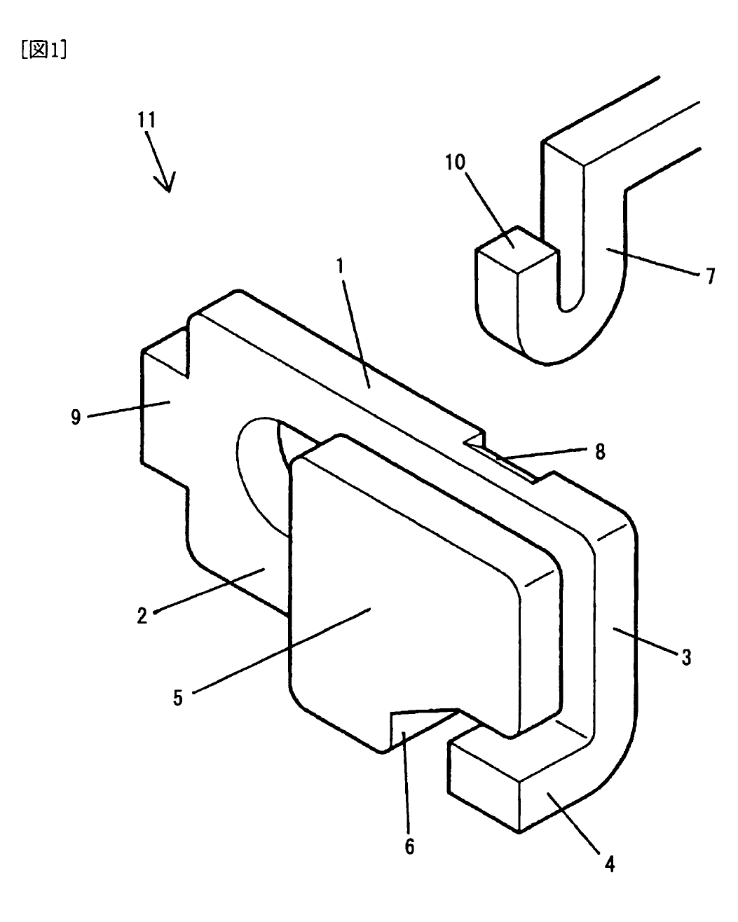

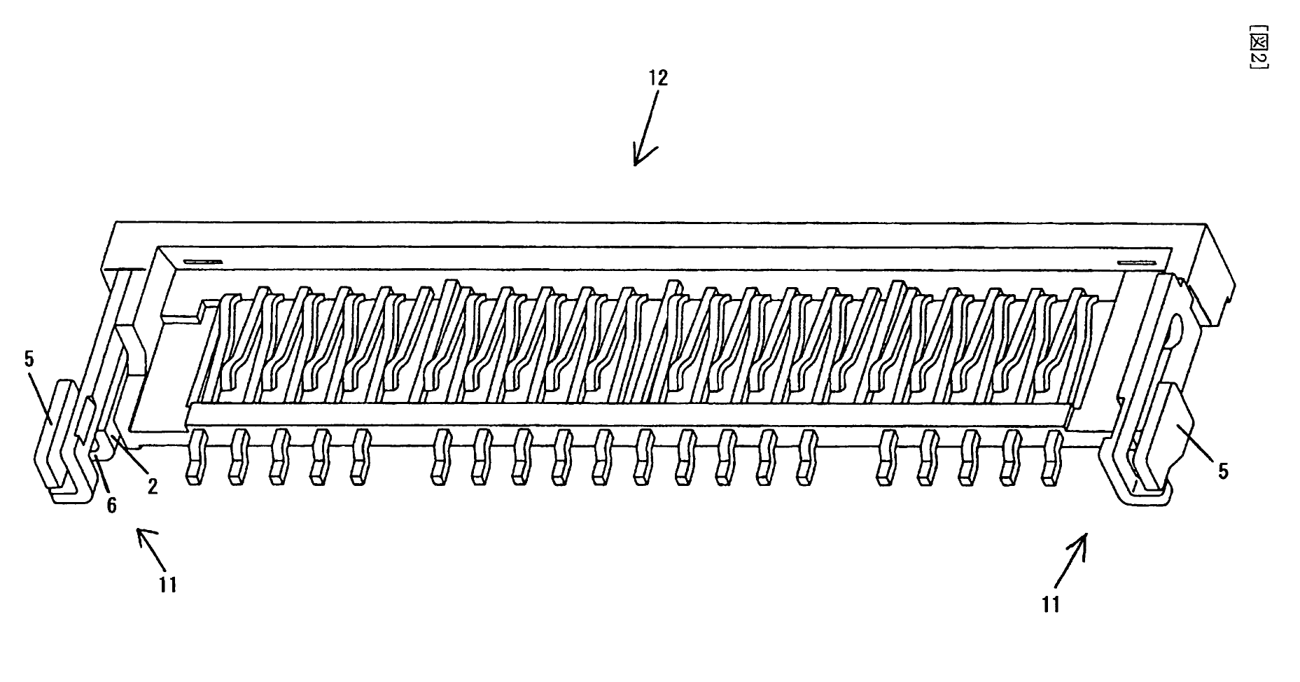

The latch structure of the present invention shall be explained with reference to the drawings. The details of the latch member 11 of the present invention are shown in FIGS. 1 and 2. The structure and functions of the latch shall be explained with reference to these drawings. First, explaining the respective parts, in the perspective view of FIG. 1, a first arm 1 extends from the far side of the drawing towards the front, and the tip extends downward to form a first projecting portion 3. It further extends roughly perpendicularly to the left to form a second projecting portion 4.

Explaining the structure in detail, the first arm 1 has a longitudinal axis and the first arm 1 has a taper 8 for guiding the corresponding engaging portion 7 of the connector during engagement. Next, a first projecting portion 3 extends from the tip of the first arm 1 in a direction roughly perpendicular to the longitudinal direction of the arm, and a second projecting portion 4 extends from the end of the first projecting portion 3 in a direction roughly perpendicular to the first projecting portion 3.

Next, in FIG. 1, a second arm 2 positioned beneath the first arm 1 extends parallel to the first arm 1 from the far side of the drawing towards the front. A communicating portion 6 extends from a tip of the second arm 2 to the left direction in the drawing, and a stopper 5 is formed on the communicating portion 6. This stopper 5 is in the shape of a flat plate that extends upward in the drawing from the communicating portion 6 as shown in the drawing.

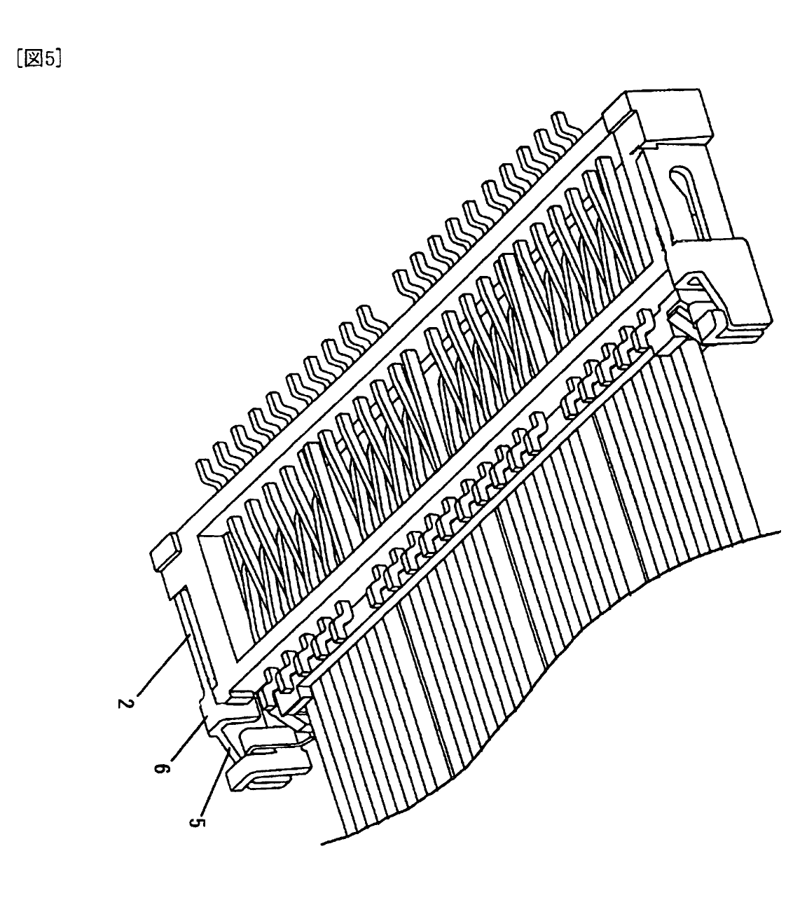

Explaining this in further detail, the second arm 2 has and extends in a longitudinal axis parallel to the first arm 1, and has a communicating portion 6 that is roughly perpendicular to the longitudinal axis and extends in a direction roughly parallel to the second projecting portion 4. The stopper 5 is connected to the communicating portion 6, the stopper 5 being formed in the shape of a flat plate and roughly parallel to the first arm 1 and second arm 2. Here, the positions and structures of the second arm 2, communicating portion 6 and stopper 5 shall be explained. FIG. 2 shows a perspective view of a connector overall including the second arm 2, the communicating portion 6 and the stopper 5. As shown in the drawing, the latch members 11 are provided symmetrically to the left and right of the second connector 12. Focusing on the latch member to the left in the drawing, the second arm 2 and the communicating portion 6 are continuously connected in a “reverse L-shape” in the drawing. The communicating portion 6 further extends in the direction of the stopper 5, and is continuously connected to a stopper 5 shown at the latch member 11 to the right of the second connector 12 in the drawing. In other words, the three parts consisting of the second arm 2, communicating portion 6 and stopper 5 are formed integrally. FIG. 5 shows this arrangement from a different angle. While FIG. 5 is a view of the entire connector including the conductive member 11 from below, as shown in the drawing, the second arm 2, the communicating portion 6 and the stopper 5 are integrally formed.

Next, explaining the structure with reference to FIG. 1, the first arm 1 and second arm 2 are connected to each other, and the first arm 1 and second arm 2 are respectively connected to a securing portion 9 for securing the latch member to the housing of the connectors. Therefore, they have a structure in which they share the securing member 9 and are connected to each other.

The functions of a latch member of this structure shall next be explained. FIG. 2 is a drawing for the case where the latch member 11 is attached to a second connector 12. As shown in the drawing, the securing portion 9 of the latch member 11 is attached to the second connector 12, and latch member 11 are attached symmetrically on both sides to the right and left of the second connector 12. A first connector is inserted into this second connector 12. At this time, the engaging portion corresponding to the first connector engages with the latch member 11.

Next, the engagement and latch operations shall be explained with reference to FIGS. 1, 3 and 4. When the first connector is inserted into the second connector, the end portion opposite to the conductive member 16 of the first connector is first inserted into the second connector. Next, the inserted end portion is used as a fulcrum to rotate the first connector to fit with the second connector. At this time, when the end portion of the first connector is inserted into the second connector, the corresponding engaging portion 7 of the connector is positioned over the first arm 1 and above the taper 8 with respect to a latch member 11 as shown in FIG. 1, and when the second connector is moved toward the first connector, the engaging portion 7 moves downward and into contact with the taper 8. When the first connector is further moved toward the second connector, the engaging portion pushes and bends the first arm 1 toward the stopper 5. The engaging portion 7 continues to move downward until the engaging surface 10 contacts the bottom surface of the first arm 1, in other words, the surface on the side facing the second arm 2. In this way, the engagement is completed.

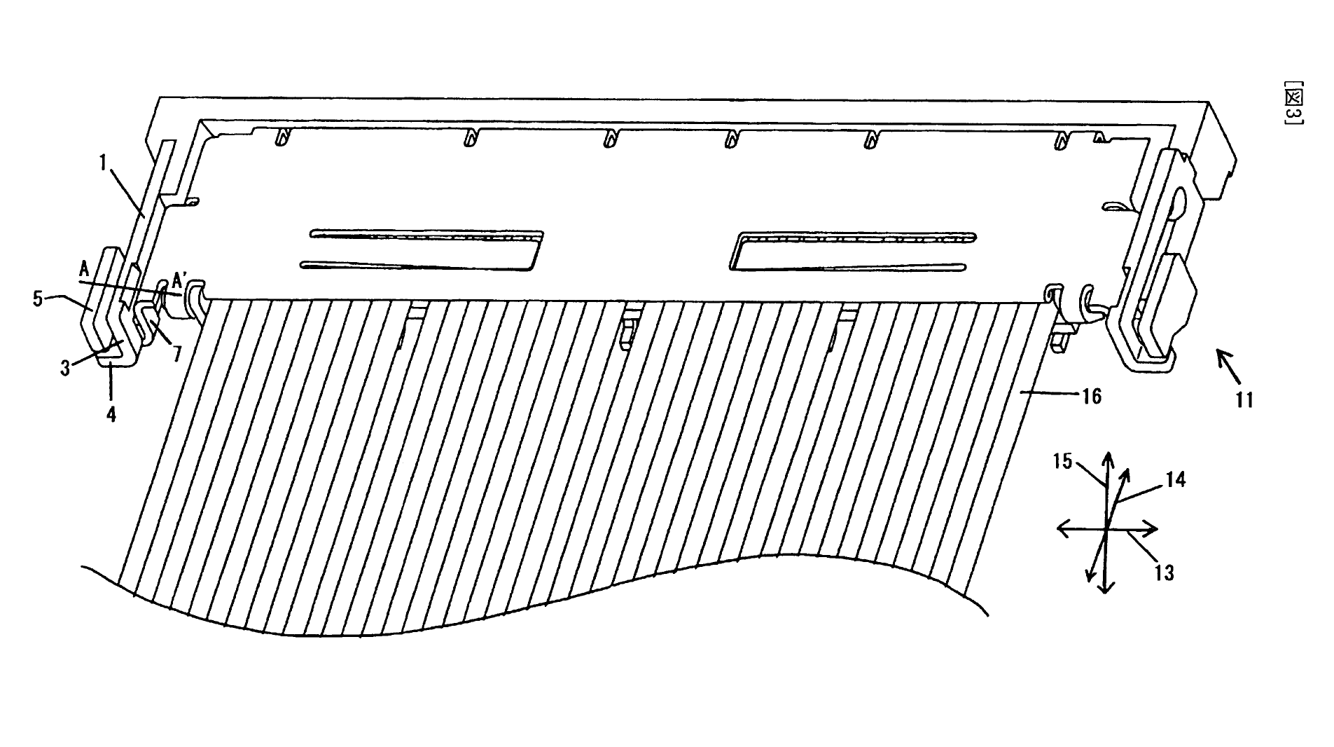

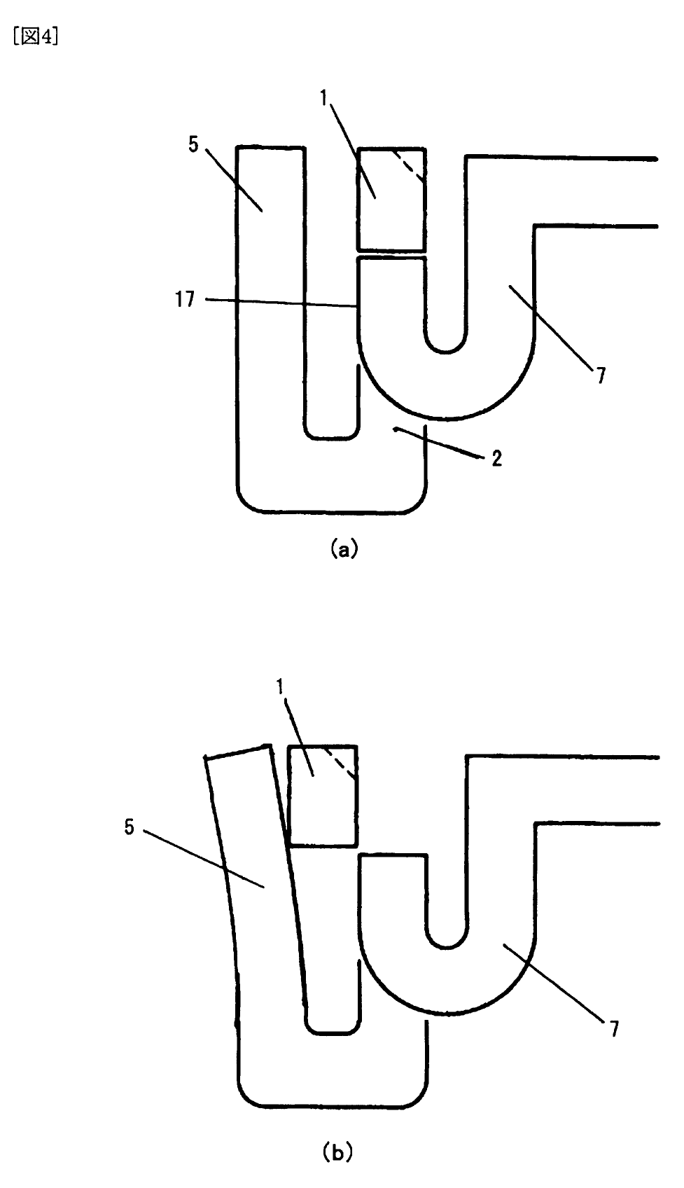

The latch mechanism in the three directions shall be explained in detail with reference to FIGS. 3 and 4. First, an explanation shall be given for the right-left direction 13. IN FIG. 3, when the connector is being removed, the first arm 1 is pressed outward, in other words towards the stopper 5 to disengage the engaging portion 7 and the first arm 1. AT this time, stress is applied to the first arm 1 due to being bent. Additionally, when the first arm 1 is formed of an elastic member or the like, there are cases of deformation or damage due to excessive or repeated forces being applied. At this time, the movement of the arm 1 is restricted by the stopper 5 contacting the first arm 1, thus preventing deformation and damage due to excessive force. Viewing this in FIG. 4 which shows a section view along the line A-A′ in FIG. 3, the engaging portion 7 is in a non-shifted state and is engaged with the first arm 1 in FIG. 4(a). Next, when the first arm 1 is pushed outward to remove the connector, the state shown in FIG. 4(b) is achieved. While the first arm 1 is spread toward the left in the drawing, it contacts the stopper 5, so that the stopper restricts its movement. While the stopper 5 can slightly bend outward as shown in the drawing, the bending causes an opposing force to be generated in the first arm so as to substantially restrict the movement of the first arm 1.

Next, latching in the front-rear direction 14 of the connector shall be described. It is clear to those skilled in the art that in FIG. 3, movement due to a force in the direction pushing the conductive member 16 toward the connector is restricted by the housing. On the other hand, a force acts to remove the connector when the conductive member is pulled in the longitudinal direction of the first arm 1. When a pulling force acts on the conductive member, the engaging portion 7 of the second connector moves in accordance with the tensile force. When the engaging portion moves a predetermined distance, the engaging portion 7 shown in FIG. 3 contacts the first projecting portion 3 of the latch member. Since the latch member 11 is secured to the housing, the first projecting portion 3 does not move in the longitudinal direction. Consequently, disengagement can be prevented even if the engaging portion 7 presses the first projecting portion. When considering FIG. 4 which is a section view along the line A-A′ in the above drawing, in (a), a portion of the engaging portion 7 is positioned in the longitudinal direction of the second arm 2 and the first arm 1 and second arm 2 are positioned on the same plane. Therefore, when the engaging portion 7 is moved towards the front in FIG. 4(a), the first projecting portion 3 (not shown in FIG. 4(a)) restricts the movement so as to maintain the engagement.

Next, the latch shall be described in the case where an up-down force is applied to the conductive member or first connector among the connectors. It is clear to those skilled in the art that when an up-down force 15 is applied to the conductive member in FIG. 3, the movement due to the up-down force in the drawing will be restricted by the housing. On the other hand, a force to raise the first connector works against the force acting in an up-down direction in the drawing, so that the engaging portion 7 presses the first arm 1 upward 15. When force is further applied, the first arm 1 bends upward. AT this time, the second projecting portion 4 which is continuously connected to the first arm comes into contact with the stopper 5. Since the stopper 5 is connected to the second arm 2 as shown in FIG. 1, a force large enough to bend the second arm 2 is needed in order to further bend the first arm 1. Consequently, the stopper 5 substantially restricts bending of the first arm 1. Consequently, latching is possible against forces applied upward.

As described above, a latch that restricts movement in the front-rear and up-down directions and will not become disengaged is achieved. Furthermore, it is possible to prevent deformation or damage to the first arm due to dynamic stresses when removing the connector.

1. A latch device for a connector; the latch device
being a member for engaging and latching when fitting together a first connector to which a conductive member is connected and a second connector having contacts for electrically connecting to a substrate;
said engaging member comprising two arms extending in a longitudinal direction; a first arm portion engaging with a corresponding engaging portion of a connector comprising a first projecting portion extending toward a second arm portion and a second projecting portion extending outward with respect to a direction of insertion of the connector; said second arm portion comprising a stopper supported on a supporting portion extending outward with respect to the direction of insertion of the connector;
the connector being latched by said stopper, when said first arm portion is bent to the outside of the contacts, coming into contact with said first arm portion to stop the bending; said first projecting portion opposing tensile force in a longitudinal direction to detain the engaging portion of said first connector; and the second projecting portion, when said first arm bends in a direction opposite to the second arm, coming into contact with said stopper to stop the bending.

2. A device in accordance with claim 1, wherein said first arm has a taper to guide said engaging portion when latching the engaging portion of said first connector.

3. A device in accordance with claim 1, wherein said first arm or second arm is formed of an elastic member.

4. A device in accordance with claim 1, wherein said engaging member is attached symmetrically to both sides of the connector.
